(19) United States
(12) Patent Application Publication
(10) Pub. No.: US 2011/0007345 A1
(43) Pub. Date: Jan. 13, 2011

(54) Mechanism for Synchronizing Documents for Multi-Print Processing

(76) Inventors: John Thomas Varga, Longmont, CO (US); Stephen Goddard Price, Longmont, CO (US); James Michael Herold, Greeley, CO (US)

Correspondence Address: InfoPrint Solutions/ Blakely, 1279 Oakmead Parkway, Sunnyvale, CA, 94085-4040, US

(21) Appl. No.: 12/499,917

(22) Filed: Jul. 9, 2009

(51) Int. Cl. G06F 15/00

(52) U.S. Cl. 358/1.15

(57) ABSTRACT

A printing system is disclosed. The printing system includes a first printer to print a first type of data to a medium and to print machine readable data on the medium including a unique identifier (ID), a database to store variable data information associated with the ID and a second printer to read the barcode to acquire the ID, retrieve the variable data from the database using the ID and print the variable data to the medium.

### FIELD OF THE INVENTION

The invention relates to the field of printing, and in particular, to printing documents on multiple print engines.

### BACKGROUND

In the printing industry, it is sometimes necessary to process media multiple times in order to create a final product. For example, media such as paper may be pre-printed in an offset press, then run through a digital press/printer in order to add unique (variable) information. In other instances, a digital printer may not have enough capability (e.g., an ink jet printer may not be able to print Magnetic Ink Character Recognition (MICR) data, or a monochrome printer may not be able to print color/highlight color).

In these cases, it may be necessary to process the media through multiple, independent digital printing devices in order to achieve the final product. To highlight their independence, the printing devices may be located in different buildings or countries and having no external network connection. Thus, the printed output may be processed hours or days apart.

When the independent printing systems are generating variable data (e.g., print data changes frequently and is very specific and personal to each piece of media), it is critical that each of the independent systems apply the correct data to the media. For instance, the media may be processed in the first printer to apply a name and address in color, then processed in a different printer to add MICR data to be used by a banking system. Therefore, it is extremely important that the variable data printed by the two independent printing systems is matched correctly.

Accordingly, a mechanism to synchronize the printers so that data can be matched to the same medium is desired.

### SUMMARY

In one embodiment, a printing system is disclosed. The printing system includes a first printer to print a first type of data to a medium and to print a first machine readable data on the medium including a unique identifier (ID), a database to store variable data information associated with the ID and a second printer to read the machine readable data to acquire the ID, retrieve the variable data from the database using the ID and print the variable data to the medium.

In a further embodiment, a method is disclosed including generating a unique ID for a document at a first printer, printing a first type of data on the document, printing the ID on the document as machine readable data, saving variable data to be printed at a second printer in a database using the ID, reading the machine readable data at the second printer to acquire the ID, retrieving the variable data associated with the ID from the database by using the ID as an index and printing the variable data on the document at the second printer.

In another embodiment, a printer is disclosed. The printer includes a first print head to print a first type of data to a medium and to print machine readable data on the medium including a unique identifier (ID) a database to store variable data information associated with the ID, a control unit to read the machine readable data to acquire the ID and retrieve the variable data from the database using the ID and second print head to print the variable data to the medium.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 is a flow diagram illustrating one embodiment of the operation of a printer; and

FIG. 3 illustrates another embodiment of a printing system.

### DETAILED DESCRIPTION

A printer synchronization mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

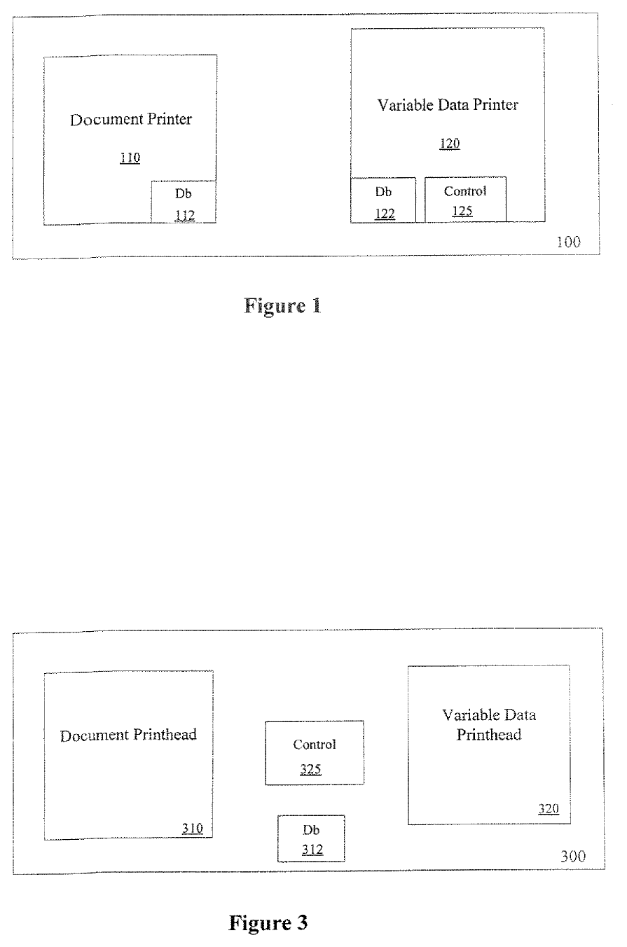

FIG. 1 illustrates one embodiment of a printing system 100. Printing system 100 includes a document printer 110 and a variable data printer 120. According to one embodiment, document printer 110 is a high speed ink jet color printer that is implemented to print image and text data on paper. In a further embodiment, printer 110 prints the images and text data on check stock for a multitude of bank account holders.

For example, printer 110 may print the address, phone number and other account holder specific data, along with one or more selected images, on each check that is printed. However, printer 110 does not have the capability to print other variable data, such as MICR. Thus, the variable data is to be printed at variable printer 120, which in some embodiments may be a monochrome printer equipped with MICR toner.

In one embodiment, printer 110 prints machine readable data (e.g., a barcode) on each document, in addition to the image and text data. However, in other embodiments the machine readable data may be replaced by human readable text that may be processed by optical character recognition. In a further embodiment, the machine readable data includes a unique ID that can be used to match the page or sheet of the document variable data printer 120. In still a further embodiment, the ID does not include useful information of any confidential data (such as encoded account numbers). Thus, the ID provides security against anyone attempting to decrypt the information on the barcode from paper scrap trimmed from the document after the document is processed at variable printer 120.

According to one embodiment, IDs may be issued per page of a document so that the pages may be printed at printer 110 to allow the use of cut sheet devices for variable printer 120. In still a further embodiment, the format of the ID includes the printer 110 serial number, a date/time stamp along with a number that is updated incrementally for each document or page printed at printer 110.

Printer 110 includes a database 112 that is implemented to store information associated with the unique ID. The additional information includes all of the instructions to print the variable data (e.g., bank account numbers) at variable printer 120. According to one embodiment, the saved information for printer 120 makes sure that the settings (e.g., paper size) are set consistently.

In a further embodiment, a print job may be preprocessed at variable data 120 to create bitmaps and speed up the recognition, retrieval, and printing performance. Further, workflow directors (e.g., InfoPrint Manager (IPM) or InfoPrint ProcessDirector (IPPD)) may utilize the IDs and their associated data to coordinate the workflow.

At some later time the document is placed into variable data printer 120 for printing of the variable data. According to one embodiment, the contents of database 112 are transferred to variable data printer 120 (electronically or mechanically) sometime before the document is to be processed at variable data 120. In one embodiment, variable data printer 120 includes a sensor to read the ID on each document and retrieves the additional print information associated with the ID from database 122. In this embodiment, the sensor reads the ID in the paper path ahead of the print head to allow time to read database 122 and format variable data printer 120 for printing. Variable data printer 120 subsequently prints the variable data on the document.

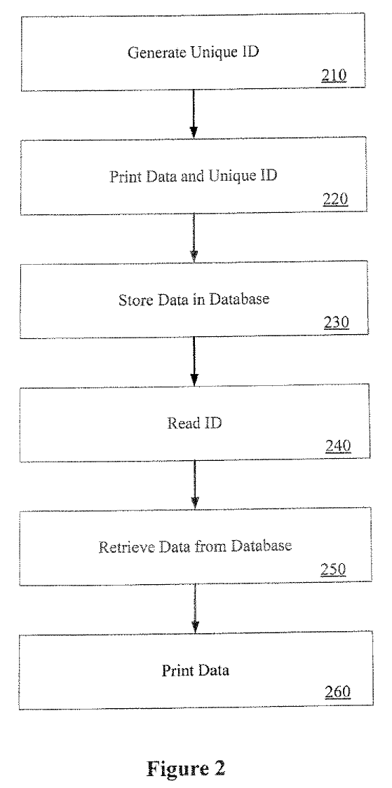

FIG. 2 is a flow diagram illustrating one embodiment of a process performed at a printing system. At processing block 210, a unique ID is generated for a document (or page of a document) processed at variable data 110. At processing block 220, the unique ID is printed in a machine readable format on the document while (or after) the print data (e.g., images and text) is printed.

At processing block 230, data to be printed at variable data 120 is saved in database 112 using the unique ID as an index. According to one embodiment, uniquely identified pages are grouped by job, paper roll, etc. At some point, the contents of database 112 are transferred via a removable media or over a network to database 122. At processing block 240, variable data 120 reads and processes the machine readable data to acquire the unique ID as the document is processed. At processing block 250, the data associated with the ID is requested and retrieved from database 122.

In one embodiment, a local copy of the data is stored at a memory device within printer 120. In a further embodiment, the local copy can be preprocessed to create appropriate bitmaps available to variable data 120. Thus, when a page is identified, variable data 120 fetches the data or bitmap by ID and formats the printed version. At processing block 260, the page is printed using the retrieved data. In a further embodiment, the printed version of the document may include another ID (e.g., derived from the first ID with extra information to be used to indicate that the data is written by a third printer).

In one embodiment, the printed page is recorded when it reaches a stack point indicating successful prints so that database 122 can track which pages have been accurately processed and notify a Host or local operator. In another embodiment, duplicate pages (reprints) include new IDs, and the database 112 at printer 110 can track which version of the page is “stacked” successfully or needs to be reprinted. As a result, only the valid versions of pages are matched, eliminating duplicate, fully-printed pages.

Variable data printer 120 may include a discard bin, to identify invalid sheets that are directed to it. By remembering printed, un-stacked pages in the database 112, the operator prompt for missing IDs can exclude these invalid sheets. The ID printed on variable data 110 may also include a decryption key, allowing the data, per page, to be encrypted and only accessible to variable data printer 120 internally by reading the public key from the printed ID. Thus the database data is secured as it flows from printer 110 to the variable data printer 120.

FIG. 3 illustrates another embodiment of a printing system. In this embodiment, both a document print head 310 and a variable data print head 320 are included in the same printer 300, where they share a database 312. This embodiment operates as discussed above with regards to FIG. 2. However in this embodiment, a single control unit 325 is implemented to generate the ID and store the associated information in database 312. Control unit 325 further reads the machine readable data on the document and retrieves the information from database 312 for printing at print head 320.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A printing system comprising:
a first printer to print a first type of data to a medium and to print machine readable data on the medium including a unique identifier (ID);
a database to store variable data information associated with the ID; and
a second printer to read the machine readable data to acquire the ID, retrieve the variable data from the database using the ID and print the variable data to the medium.

2. The printing system of claim 1 wherein the database is transferred from the first printer to the second printer after the medium is processed at the first printer.

3. The printing system of claim 1 wherein a local copy of the variable data is stored in memory at the second printer after being retrieved from the database.

4. The printing system of claim 3 wherein the local copy of the variable data is preprocessed at the second printer.

5. The printing system of claim 1 wherein the database includes an entry indicating whether the medium was successfully processed at the first printer and the second printer.

6. The printing system of claim 1 wherein the second printer includes a discard bin to identify the document as being invalid due to improper processing at the first printer or the second printer.

7. The printing system of claim 1 wherein the ID includes a serial number of the first printer, a date/time stamp and an incremented number.

8. The printing system of claim 1 wherein the first type of data comprises at least one of text data and image data.

9. A method comprising:
generating a unique ID for a document at a first printer;
printing a first type of data on the document;
printing the ID on the document as machine readable data;
saving variable data to be printed at a second printer in a database using the ID;
reading the machine readable data at the second printer to acquire the ID;
retrieving the variable data associated with the ID from the database by using the ID as an index; and
printing the variable data on the document at the second printer.

10. The method of claim 9 further comprising transferring the database from the first printer to the second printer after the document is processed at the first printer.

11. The method of claim 9 further comprising storing a local copy of the variable data in memory at the second printer after the variable data is retrieved from the database.

12. The method of claim 11 further comprising preprocessing the local copy of the variable data at the second printer.

13. The method of claim 9 further comprising identifying the document in the database as being successfully processed at the first printer and the second printer

14. The method of claim 13 further routing the document to a discard bin at the second printer if the document is invalid due to improper processing at the first printer or the second printer.

15. A printer comprising:
a first print head to print a first type of data to a medium and to print machine readable data on the medium including a unique identifier (ID);
a database to store variable data information associated with the ID;
a control unit to read the machine readable data to acquire the ID and retrieve the variable data from the database using the ID; and
a second print head to print the variable data to the medium.

16. The printer of claim 15 wherein the control unit stores a local copy of the variable data in memory after retrieving variable data from the database.

17. The printer of claim 16 wherein the control unit preprocesses the local copy of the variable data.

18. The printer of claim 15 wherein the database includes an entry indicating whether the medium was successfully processed at the first printer and the second printer.

19. The printer of claim 15 further comprising a discard bin to identify the document as being invalid due to improper processing at the first printer or the second printer.

20. The printer of claim 15 wherein the first type of data comprises at least one of text data and image data.
